(19) United States
(12) Patent Application Publication
(10) Pub. No.: US 2003/0145181 A1
(43) Pub. Date: Jul. 31, 2003

(54) Optical recording medium preventing illegal dublication, and a method for manufacturing and reproducing the same, and an authentication method using the same

(76) Inventor: Tae-Hoo Bae, Anyang-city (KR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/182,280

(22) PCT Filed: Jan. 26, 2001
(86) PCT No.: PCT/KR01/00110

(30) Foreign Application Priority Data
Jan. 27, 2000 (KR) 2000/4073

(51) Int. Cl. G06F 13/28; G06F 12/14; H04L 9/00; G11B 7/00

(52) U.S. Cl. 711/163; 369/53.21; 705/57

(57) ABSTRACT

Disclosed is a method for manufacturing an optical recording medium including an authentication data region and a recording data region. The method comprises: recording at least one intentional error data portion on the authentication data region; and storing an officially certified product determining program that stores authentication information corresponding to the recorded intentional error data in the recording data region. Therefore, the officially certified product determining program determines whether the authentication information and the intentional error data are matched, and only when they are matched is the optical recording medium determined to be an officially certified product, and subsequent program operations are executed.

### BACKGROUND OF THE INVENTION

(a) Field of the Invention

The present invention relates to an optical recording medium. More specifically, the present invention relates to an optical recording medium with a duplication preventing function, and a method for manufacturing, reproducing and authenticating the optical recording medium.

(b) Description of the Related Art

Optical recording media such as compact discs (CD) and digital versatile discs (DVD) store a large capacity of information and are widely used for storing digital signals because of the quality of the signals, but as techniques for duplicating the optical recording media are developed, illegal duplication of the optical recording media is becoming a big social problem.

That is, because one of the merits of the optical recording media is that duplicated data have a quality identical with that of the original data, commercial optical recording media can be unlawfully duplicated.

To solve this problem, the signals recorded on the optical recording media have conventionally been distorted, or specific marks are recorded on a region where general users cannot access. However, the duplication preventing techniques need expensive special devices, and in the case a decoder is provided to the duplication prevention device, the data can still be duplicated.

### SUMMARY OF THE INVENTION

It is an object of the present invention to provide an optical recording medium having a duplication preventing function.

In one aspect of the present invention, in an optical recording medium readable by a computer, an optical recording medium having an illegal-duplication preventing function comprises: an authentication data region including at least one intentional error data portion; and a recording data region having an officially certified product determining program that stores authentication information on the intentional error data, compares the stored authentication information with the intentional error data and determines whether the optical recording medium is duplicated.

In another aspect of the present invention, in a method for manufacturing an optical recording medium including an authentication data region and a recording data region, the method comprises: recording at least one intentional error data on the authentication data region; and storing an officially certified product determining program that stores authentication information corresponding to the recorded intentional error data in the recording data region.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 shows an optical recording medium having a duplication preventing function according to a preferred embodiment of the present invention;

FIG. 2 shows a flow chart of a method for reproducing an optical recording medium having a duplication preventing function according to the preferred embodiment of the present invention;

FIGS. 3 to 5 show various recording regions of intentional error data according to the preferred embodiment of the present invention; and

FIG. 6 shows an on-line authentication system of an optical recording medium according to the preferred embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

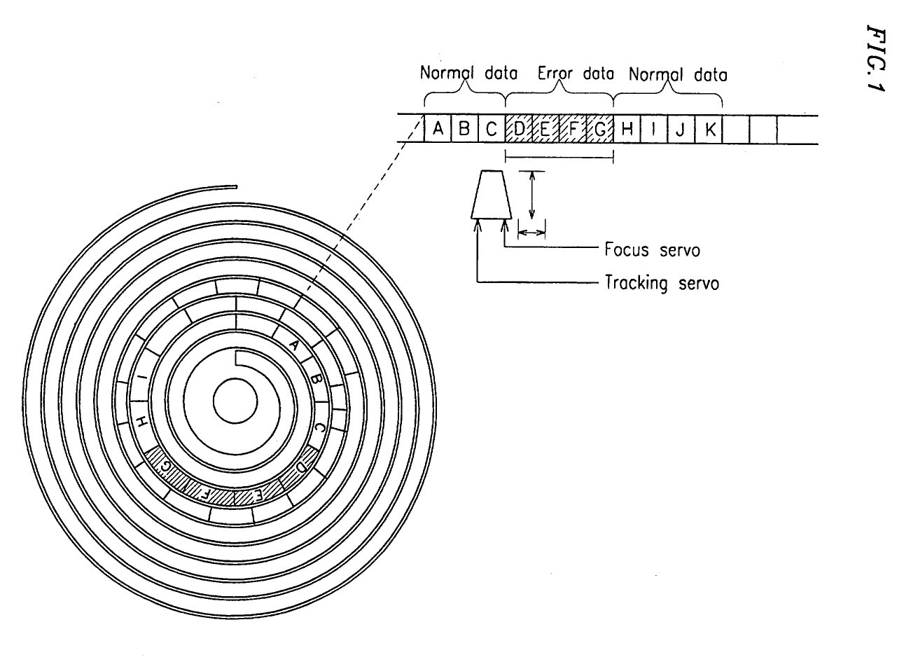

FIG. 1 shows an optical recording medium having a duplication preventing function according to a preferred embodiment of the present invention.

As shown, the optical recording medium having a duplication preventing function has intentional error data recorded on predetermined sectors (sectors D to G as shown in FIG. 1) in the process of its manufacture. In general, the data recorded on the optical recording medium are read by an optical pickup device, that is, a head unit that is moved in the top and bottom directions by a focus servo and moved in the right and left directions by a tracking servo. In detail, the optical pickup device reads data according to reflection of beams applied to pits and lands on the optical recording medium. In this instance, each sector comprises a plurality of pits and lands on which data are recorded.

A description of how the intentional error data are recorded is as follows.

First, in the case of the optical recording medium on which the data have been recorded, intentional errors are generated on some portions of data recorded regions by methods such as scratching, eroding, coating, perforating and applying stickers.

Second, normal data and error data can be concurrently recorded on the optical recording medium. That is, the error data can be accurately recorded on desired locations by using an optical-recording-medium recording device that is modified to distort recording signals. In detail, by using a feature so that the optical-recording-medium recording device only reproduces the pits formed of predetermined sizes of 3T to 11T, the modified optical recording-medium recording device records the pits having sizes excluding values of 3T to 11T on the optical recording medium. As described above, when the optical recording medium recording device reads the error data, the data might not be read, or each time the data are read the reading results become different, and therefore malfunction states can be determined.

As shown in FIG. 1 and Table 1, normal data are recorded on A, B, C, H, I, J, K, . . . , and error data are recorded on D, E, F and G among the data streams (A, B, C, . . . ) spirally expanding in the clockwise direction.

TABLE 1

| Address | Data value | Comparison |
|---|---|---|
| 0001 | A | Readable |
| 0002 | B | Readable |
| 0003 | C | Readable |
| 0004 | D | Reading errors occur because of the intentional |
| | | errors |
| 0005 | E | Reading errors occur because of the intentional |
| | | errors |
| 0006 | F | Reading errors occur because of the intentional |
| | | errors |
| 0007 | G | Reading errors occur because of the intentional |
| | | errors |
| 0008 | H | Readable |
| 0009 | I | Readable |
| 0010 | J | Readable |

As shown in Table 1, authentication information stored in a built-in program of the optical recording medium comprises the C that is the value of the address ‘0003’ before the starting of the intentional error data region; an intentional error data region starting address ‘0004’; an intentional error data region ending address ‘0007’; and the H that is the value of the address ‘0008’ next the intentional error data region.

In the preferred embodiment, a method for determining whether the corresponding optical recording is an officially certified product in the case the program stored in the optical recording medium is operated (e.g., the program is reproduced) is as follows.

In the preferred embodiment, a function for interpreting authentication information (a program having this function will be referred to as an officially certified copy determining program, hereinafter) is added to a user program such as an application program or an installation program so as to prohibit illegal duplications. In detail, when the optical recording medium is reproduced and the built-in program is accordingly operated, authentication information on the intentional error data is automatically recorded to the officially certified copy determining program, and the officially certified copy determining program compares recorded authentication information with intentional error information actually read from the optical recording medium so as to check matching states and accordingly illegal duplication states. That is, the officially certified copy determining program checks the values read from the optical recording medium, for example, whether the values of the addresses ‘0002’ and ‘0003’ are B and C, checks whether reading failures are generated when accessing addresses ‘0004’ to ‘0007’, and checks whether values of addresses ‘0008’ and ‘0009’ are respectively H and I so as to determine matching states with previously stored authentication information, and only when the previously stored authentication information is matched with intentional error data read from the optical recording medium does the officially certified copy determining program normally execute corresponding operations, and therefore, illegal duplications of the optical recording medium are prevented.

As described above, illegal duplication states can be determined by recording the intentional error data on the optical recording medium, according to the following reasons.

The optical recording media reads values via optical reflection signals. Since a region occupied by an address is very small (e.g., the dimension of a conventional pit is 0.12 μm in depth and 0.6 μm in width), it is almost impossible to record the intentional error data so as to have an identical failure range at an accurate location (address), and therefore it is impossible to accurately duplicate the addresses of the intentional error data that match the authentication information stored in the officially certified product determining program and the values recorded at the addresses before and after the addresses of the intentional error data on the illegally duplicated optical recording medium.

As described above, after failure data are recorded on a predetermined portion of the optical recording medium so as to generate an intentional error data region, and the value of the address before the intentional error region, the starting address of the intentional error region, the last address of the intentional error region, and the value of the address after the intentional error region are stored in the officially certified product determining program as authentication information, the authentication information stored when reproducing the optical recording medium and the intentional error data read when reading the actual optical recording medium are compared to determine illegal duplication states.

In addition, values of other addresses that are not in the intentional error data region can also be used.

In the above-noted preferred embodiment, the intentional error data are provided on a single track, and the intentional error data can also be provided on at least two tracks.

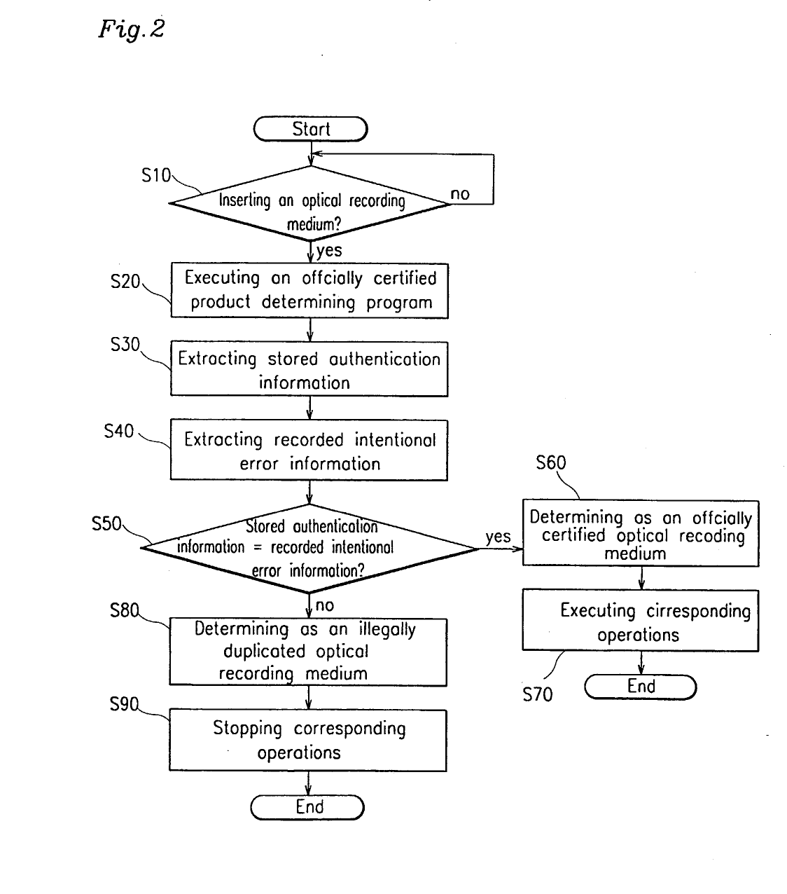

FIG. 2 shows a flow chart of a method for reproducing an optical recording medium having a duplication preventing function according to the preferred embodiment of the present invention.

As shown, when an optical recording medium is inserted into an optical-recording-medium reproducing device such as a CD-ROM driver in step S10, an officially certified product determining program stored in the optical recording medium is executed in step S20.

The officially certified product determining program extracts stored authentication information in step S30, and extracts intentional error data recorded on the optical recording medium in step S40.

The officially certified product determining program checks whether the authentication information is matched with the intentional error data in step S50, and in the case they are matched, the optical recording medium is determined to be an officially certified product in step S60, and the corresponding program is normally executed in step S70.

When they are not matched in the previous step S50, the optical recording medium is determined to be an illegally duplicated product in step S80, and operations of a corresponding program are stopped in step S90.

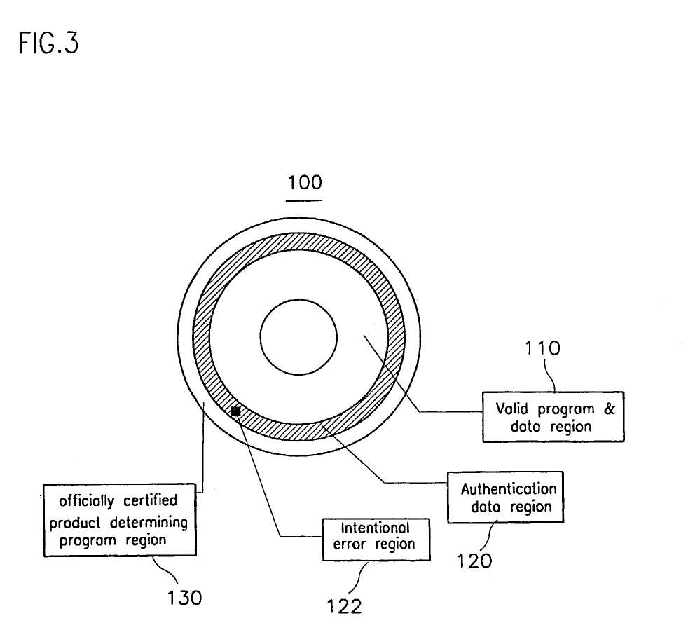

FIG. 3 shows a first recording region of intentional error data according to the preferred embodiment of the present invention.

As shown, the optical recording medium 100 having a duplication preventing function comprises a first region 110 for storing valid programs and data; a second region 120, an authentication data region for recording intentional error data 122 and invalid data; and a third region 130 for storing an officially certified product determining program. Here, the intentional error data are recorded on a predetermined portion of the authentication region 120 via methods such as scratching, eroding, coating, perforating, and applying stickers in the process of manufacturing the optical recording media. Some address values of regions on which the invalid data adjacent to the intentional error data 122 among the authentication data region 120 are recorded (e.g., an address immediately preceding the start address of the intentional error data region, or an address immediately after the last address of the intentional error data region) are used for authenticating the optical recording media.

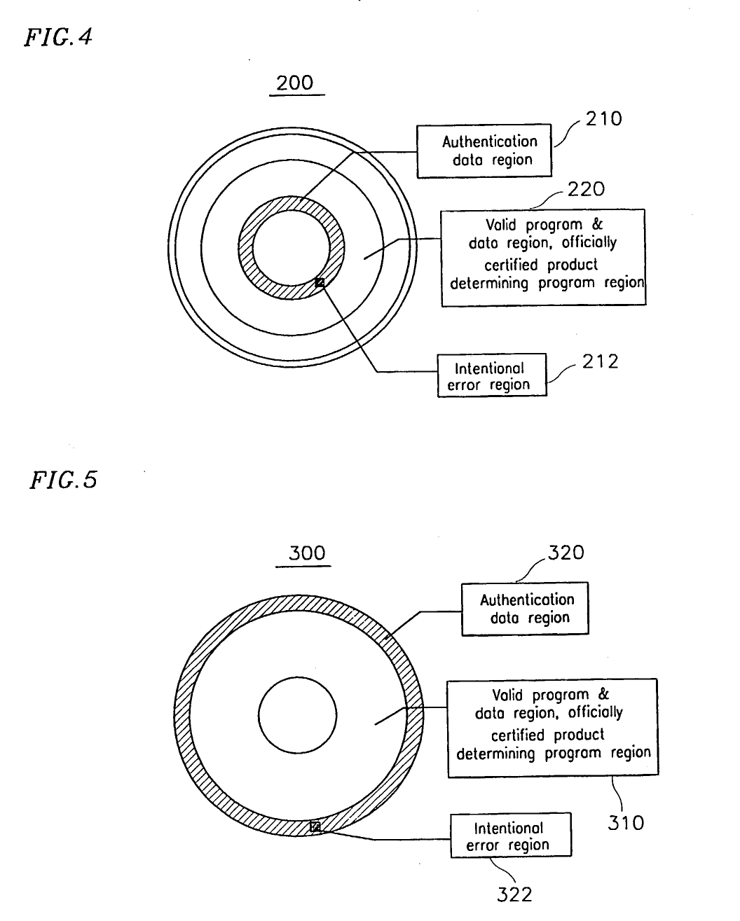

FIG. 4 shows a second recording region of the intentional error data according to the preferred embodiment of the present invention.

As shown, the optical recording medium having a duplication preventing function comprises a first region 210 for storing intentional error data 212 and invalid data; and a second region 220 for storing valid programs, data and an officially certified product determining program. Here, the intentional error data 212 are recorded on a predetermined portion of the first region 210 via methods such as scratching, eroding, coating, perforating and applying stickers in the process of manufacturing the optical recording media.

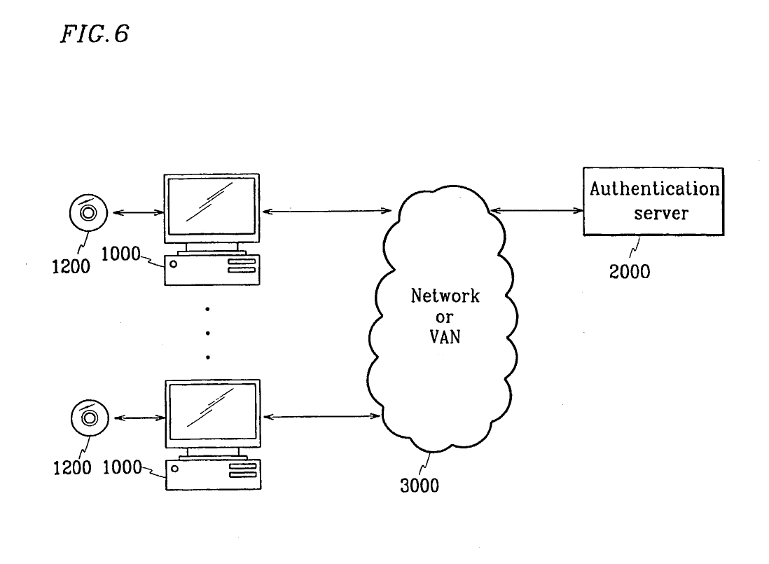

FIG. 5 shows a third recording region of the intentional error data according to the preferred embodiment of the present invention.

As shown, the optical recording medium having a duplication preventing function comprises a first region 310 for storing valid programs, data and an officially certified product determining program; and a second region 320, an authentication region for storing intentional error data 322 and invalid data. Here, the intentional error data 322 are recorded on a predetermined portion of the second region 320 via methods such as scratching, eroding, coating, perforating, and applying stickers in the process of manufacturing the optical recording media.

Referring to FIGS. 3 to 5, the intentional error data are recorded on a single portion of the optical recording medium, and further, it is also possible to record the intentional error data on at least two portions of the optical recording medium.

In the above, an officially certified product determining program that searches the value of the address immediately preceding the address of the intentional error region, a starting address of the intentional error region, a last address of the intentional error region, and the value of the address immediately after the address of the intentional error region is provided on an optical recording medium, and when the officially certified product determining program finds that stored authentication information is not matched with intentional error data, the optical recording medium is determined to be illegal, and no more operations are activated.

Further, the optical recording medium can be used as an on-line authentication device in the like manner of electronic commerce, and in this case, the above-described duplication preventing technique can also be applied.

FIG. 6 shows an on-line authentication system of an optical recording medium according to the preferred embodiment of the present invention.

As shown, the authentication system comprises an optical recording medium 1200 for recording intentional error data; a user computer 1000 having a reader for reading the optical recording medium; and an authentication server 2000, connected to the user computer via a network or a VAN 3000, for storing authentication information corresponding to the intentional error data stored on the optical recording medium. The authentication server 2000 compares the previously stored authentication information with the intentional error data read from the optical recording medium 1200 and performs an authentication process. In this instance, since the intentional error data recorded on the optical recording medium and the authentication information stored in the authentication server are described in the previous embodiment, no further description will be provided.

A method for authenticating an optical recording medium on a network will be described.

As shown in FIG. 6, when an optical recording medium 1200 having a duplication preventing function is inserted into a computer 1000, the authentication server 2000 extracts the intentional error data recorded on the optical recording medium via the network or the VAN, and in the case the intentional error data are compared with the previously stored authentication information and they are found to be matched, an authentication message is provided to the optical recording medium, and access to information that requires the authentication or program use is allowed.

When they are not matched, a message that the optical recording medium is an illegally duplicated product is generated, and access to desired information is prohibited or a process for reproducing the program is stopped.

According to the above-described preferred embodiment, in order to authenticate the optical recording medium on the network, the value of the address immediately preceding the intentional error region, the starting address of the intentional error region, the last address of the intentional error region, and the value of the address immediately after the intentional error region are searched using the authentication server on the network, and when these values are not matched with the value immediately preceding the previously established intentional error region, the starting address of the intentional error region, the last address of the intentional error region, and the value of a next address of the intentional error region, the product is found to be illegally duplicated.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. In an optical recording medium readable by a computer, an optical recording medium having an illegal duplication preventing function comprising:
an authentication data region including at least one intentional error data portion; and
a recording data region having an officially certified product determining program that stores authentication information on the intentional error data and compares the stored authentication information with the intentional error data to determine whether the optical recording medium is duplicated.

2. The medium of claim 1, wherein a built-in program is normally executed when the officially certified product determining program determines that the intentional error data are matched with the authentication information, and the built-in program is stopped when they are not matched.

3. The medium of claim 1, wherein the intentional error data are recorded on a predetermined portion of the data region recorded on the optical recording medium on which the data have been recorded, by using at least one method such as scratching, eroding, coating, perforating, and applying stickers.

5. The medium of claim 1, wherein the intentional error data are concurrently recorded on the optical recording medium when the data are recorded on the optical recording medium.

6. The medium of claim 5, wherein the intentional error data are recorded on the optical recording medium with sizes excluding the sizes of 3T to 11T.

7. The medium of claim 1, wherein the authentication information comprises a starting address of the intentional error data, a last address of the intentional error data, a value of a first address adjacent to the starting address of the intentional error data, and a value of a second address adjacent to the last address of the intentional error data.

8. The medium of claim 7, wherein the authentication data region comprises an invalid data region adjacent to the intentional error data region, for recording invalid data, and the first and second addresses are provided in the invalid data region.

9. The medium of claim 8, wherein the first address immediately precedes the starting address of the intentional error data region, and the second address is immediately after the last address of the intentional error data region.

10. The medium of claim 1, wherein the authentication data region is provided between the data region and the officially certified product determining program region.

11. The medium of claim 1, wherein the authentication data region is provided at a starting portion of the optical recording medium.

12. The medium of claim 1, wherein the authentication data region is provided at a last portion of the optical recording medium.

13. In a method for manufacturing an optical recording medium including an authentication data region and a recording data region, the method comprising:
recording at least one intentional error data portion on the authentication data region; and
storing an officially certified product determining program that stores authentication information corresponding to the recorded intentional error data in the recording data region.

14. The method of claim 13, wherein the authentication information comprises a starting address of the intentional error data, a last address of the intentional error data, a value of a first address adjacent to the starting address of the intentional error data, and a value of a second address adjacent to the last address of the intentional error data.

15. In a method for reproducing an optical recording medium is readable by a computer, a method for reproducing an optical recording medium having a duplication preventing function comprising:
extracting intentional error data recorded on the optical recording medium, and extracting authentication information that is stored in an officially certified product determining program provided on the optical recording medium and that corresponds to the intentional error data; and
comparing the intentional error data with the authentication information to determine duplication states of the optical recording medium.

16. The method of claim 15, wherein the method further comprises:
normally executing the program in the case the intentional error data and the authentication information are matched; and
stopping the program in the case they are not matched.

17. The method of claim 14, wherein the authentication information comprises a starting address of the intentional error data, a last address of the intentional error data, a value of a first address adjacent to the starting address of the intentional error data, and a value of a second address adjacent to the last address of the intentional error data.

18. An on-line optical recording medium authenticating system comprising:
an optical recording medium for recording intentional error data;
a computer having a reader for reading the optical recording medium; and
an authentication server, connected to the computer via a network, for storing authentication information corresponding to intentional error data stored in the optical recording medium, comparing the intentional error data read from the optical recording medium with the authentication information, and executing an authentication process.

19. The system of claim 18, wherein the authentication information comprises a starting address of the intentional error data, a last address of the intentional error data, a value of a first address adjacent to the starting address of the intentional error data, and a value of a second address adjacent to the last address of the intentional error data.

20. An authentication method of an authentication system connected to a computer to which an optical recording medium on which intentional error data are recorded is provided via a network, and that stores authentication information corresponding to the intentional error data, the method comprising:
extracting the intentional error data recorded on the optical recording medium; and
comparing the extracted intentional error data with the previously stored authentication information and checking authentication states.

21. The method of claim 20, wherein the method comprises:
allowing access to information or reproduction of a program that requires authentication when the intentional error data and the authentication information are matched; and
stopping access to information or reproduction of a program that requires authentication when the intentional error data and the authentication information are not matched.

22. The method of claim 21, wherein the authentication information comprises a starting address of the intentional error data, a last address of the intentional error data, a value of a first address adjacent to the starting address of the intentional error data, and a value of a second address adjacent to the last address of the intentional error data.
